(19) United States
(12) Patent Application Publication
(10) Pub. No.: US 2012/0045670 A1
(43) Pub. Date: Feb. 23, 2012

(54) AUXILIARY ELECTRODES FOR ELECTROCHEMICAL CELLS CONTAINING HIGH CAPACITY ACTIVE MATERIALS

(75) Inventors: Constantin I. Stefan, San Jose, CA (US); Rainer J. Fasching, Mill Valley, CA (US); Gregory Alan Roberts, Oakland, CA (US); Ryan Kottenstette, Los Altos, CA (US); Song Han, Foster City, CA (US); Ghyrn E. Loveness, East Palo Alto, CA (US)

(73) Assignee: AMPRIUS, INC., Menlo Park, CA (US)

(21) Appl. No.: 13/245,530

(22) Filed: Sep. 26, 2011

Related U.S. Application Data
(63) Continuation-in-part of application No. 12/944,593, filed on Nov. 11, 2010.
(60) Provisional application No. 61/386,868, filed on Sep. 27, 2010.
(60) Provisional application No. 61/260,294, filed on Nov. 11, 2009.

(51) Int. Cl. H01M 10/48; H01M 10/00; H01M 10/0525

(52) U.S. Cl. 429/61; 429/231.95; 429/94; 29/623.1

(57) ABSTRACT

Provided are novel electrochemical cells that include positive electrodes, negative electrodes containing high capacity active materials such as silicon, and auxiliary electrodes containing lithium. An auxiliary electrode is provided in the cell at least prior to its formation cycling and is used to supply lithium to the negative electrode. The auxiliary electrode may be then removed from the cell prior or after formation. The transfer of lithium to the negative electrode may be performed using a different electrolyte, a higher temperature, and/or a slower rate than during later operational cycling of the cell. After this transfer, the negative electrode may remain pre-lithiated during later cycling at least at a certain predetermined level. This pre-lithiation helps to cycle the cell at more optimal conditions and to some degree maintain this cycling performance over the operating life of the cell. Also provided are methods of fabricating such cells.

### CROSS-REFERENCE TO RELATED APPLICATIONS

This application claims the benefit under 35 U.S.C. §119(e) of U.S. Provisional Patent Application No. 61/386,868, entitled “AUXILIARY ELECTRODES FOR ELECTROCHEMICAL CELLS CONTAINING HIGH CAPACITY ACTIVE MATERIALS” filed on Sep. 27, 2010 (Attorney Docket No. AMPRP015P), which is incorporated herein by reference in its entirety.

This application is also a continuation-in-part of U.S. patent application Ser. No. 12/944,593, entitled “PRELOADING LITHIUM ION CELL COMPONENTS WITH LITHIUM,” filed on Nov. 11, 2010 (Attorney Docket AMPRP006US), which is a non-provisional of U.S. Provisional Patent Application No. 61/260,294, entitled “PRELOADING LITHIUM ION CELL COMPONENTS WITH LITHIUM,” filed on Nov. 11, 2009 (Attorney Docket AMPRP006P). All of these patent applications are incorporated herein by reference in their entireties for all purposes.

### BACKGROUND

The demand for high capacity rechargeable electrochemical cells is strong. Many areas of application, such as aerospace, medical devices, portable electronics, and automotive, require high gravimetric and/or volumetric capacity cells. Lithium ion technology represents a significant improvement in this regard. However, to date, application of this technology has been primarily limited to graphite negative electrodes, and graphite has a theoretical capacity of only 372 mAh/g during lithiation.

Silicon, germanium, tin, and many other materials are attractive negative active materials because of their high electrochemical capacities. For example, the theoretical capacity of silicon during lithiation is estimated at about 4,200 mAh/g. However, many of these materials have not been widely adopted because of poor cycle life performance of cells fabricated with these materials. One reason is the substantial change in volume these materials undergo during cycling. Silicon, for example, swells by as much as 400% when it is lithiated to its maximum capacity. Volume changes of such magnitudes can cause considerable stresses in high capacity active material structures resulting in fractures and pulverization, losses of electrical connections within the electrode, and significant capacity fading. Furthermore, cells fabricated with high capacity active materials experience considerable losses of lithium ions available as charge carriers due to SEI layer formation and other reasons. These losses are believed to be much higher than in conventional graphite based cells.

### SUMMARY

Provided are novel electrochemical cells that include positive electrodes, negative electrodes containing high capacity active materials such as silicon, and auxiliary electrodes containing lithium. An auxiliary electrode is provided in the cell at least prior to its formation cycling and is used to supply lithium to the negative electrode. The auxiliary electrode may be then removed from the cell prior or after formation. The transfer of lithium to the negative electrode may be performed using a different electrolyte, a higher temperature, and/or a slower rate than during later operational cycling of the cell. After this transfer, the negative electrode may remain pre-lithiated during later cycling at least at a certain predetermined level. This pre-lithiation helps to cycle the cell at more optimal conditions and to some degree maintain this cycling performance over the operating life of the cell. Also provided are methods of fabricating such cells.

In certain embodiments, a rechargeable electrochemical cell includes a positive electrode having a positive electrode lithiation capacity and a negative electrode containing a high capacity active material and having a negative electrode lithiation capacity greater than the positive electrode lithiation capacity. A total amount of lithium in this rechargeable electrochemical cell that is contained in the positive electrode and the negative electrode exceeds the positive electrode lithiation capacity. Some examples of the high capacity active material of silicon, tin, and germanium.

In certain embodiments, after formation cycling, the negative electrode continues to retain a predetermined minimal amount of lithium at any point during cycling of the rechargeable electrochemical cell. For example, the predetermined minimal amount of lithium may correspond to at least about 500 mAh/g based on the weight of the high capacity active material and/or to a voltage of the negative electrode versus lithium of less than about 200 mV.

Provided also is a rechargeable electrochemical cell including a positive electrode having, a negative electrode containing a high capacity active material, and an auxiliary electrode in ionic communication with the positive electrode and the negative electrode, the auxiliary electrode comprising lithium. The negative electrode lithiation capacity of the negative electrode or, more specifically, of the high capacity action materials greater than the positive electrode lithiation capacity of the positive electrode. Examples of the high capacity active material include silicon, tin, and germanium.

An electrochemical cell may also include a cell management circuit in electrical communication with the positive electrode, the negative electrode, and the auxiliary electrode. The cell management circuit may be configured to independently measure and maintain voltages at predetermined levels between the negative electrode and the auxiliary electrode and between the positive electrode and the auxiliary electrode. In certain embodiments, the cell management circuit is configured to maintain voltage between the negative electrode and the auxiliary electrode at a level of less than about 200 mV.

In certain embodiments, a rechargeable electrochemical cell may include a second auxiliary electrode. The two auxiliary electrodes are positioned adjacent to two opposite edges of the negative electrode. In certain embodiments, the positive and negative electrodes are arranged into a jelly roll. In these embodiments, the auxiliary electrode is positioned adjacent to one end of the jelly roll. In other embodiments, the positive and negative electrodes are arranged into a stack, and the auxiliary electrode is positioned along one edge of the stack. In certain embodiments, an auxiliary electrode comprises lithium foil. The total amount of lithium in the rechargeable electrochemical cell contained in the positive electrode, the negative electrode, and the auxiliary electrode may exceed the positive electrode lithiation capacity.

Provided also is a method of fabricating a rechargeable electrochemical cell. The method may start with providing a cell assembly that includes a positive electrode, a negative electrode containing a high capacity active material, an auxiliary electrode comprising lithium, and an electrolyte providing ionic communication among the positive electrode, the negative electrode, and the auxiliary electrode. The method then involves causing an electrical current between the negative electrode and the auxiliary electrode to transfer a portion of the lithium from the auxiliary electrode to the negative electrode. For example, the current may be caused by externally interconnecting the negative and auxiliary electrodes. These electrodes may be interconnected directly or through a resistor or some other circuitry that allows controlling the current between the two electrodes and/or voltage between the two electrodes. The electrical current may have a rate of less than about C/10. Lithium may be transferred while the cell assembly is heated to at least about 30° C.

In certain embodiments, lithium may be transferred until a voltage between the negative electrode and the auxiliary electrode is less than about 200 mV. Various other types of cut off points may be used for this operation. For example, lithium may be transferred from the auxiliary electrode to the negative the electrical until at least about 75% of lithium initially present on the auxiliary electrode is transferred to the negative electrode. In the same or other embodiments, wherein lithium is transferred from the auxiliary electrode to the negative the electrical until at least about 500 mAh/g of lithium, based on weigh of high capacity active material, is transferred from the auxiliary electrode to the negative electrode. Lithium may be transferred from the auxiliary electrode to the negative the electrical until substantially no lithium remains on the auxiliary electrode.

In certain embodiments, the method also involves conducting one or more formation cycles such that the negative electrode continues to retain the portion of the lithium transferred from the auxiliary electrode during the one or more formation cycles. The formation cycles may be conducted after transferring the portion of the lithium from the auxiliary electrode to the negative electrode. Conducting these formation cycles may involve monitoring (i) a positive electrode voltage between the positive electrode and the auxiliary electrode and/or (ii) a negative electrode voltage between the negative electrode and the auxiliary electrode.

In certain embodiments, the method involves removing the auxiliary electrode from the cell assembly and sealing the positive electrode and the negative electrode inside a cell case. The auxiliary electrode may be provided on a temporary structure used for containment of the electrolyte in the cell assembly while transferring lithium from the auxiliary electrode to the negative electrode. This structure may be then removed and replaced with another one that is used, for example, for final sealing of the cell after the auxiliary electrode is removed. The method may also involve outgassing the cell assembly prior to sealing the positive electrode and the negative electrode inside the cell case. In certain embodiments, the method may involve removing a portion of the electrolyte from the cell assembly prior to sealing the positive electrode and the negative electrode inside the cell case. The method may also involve replacing at least a portion of the electrolyte from the cell assembly with a new electrolyte. This operation may be performed prior to sealing the positive electrode and the negative electrode inside the cell case. The new electrolyte may have a higher conductivity than the portion of the electrolyte removed from the cell. In certain embodiments, the new electrolyte includes at least about 0.5M of a lithium containing salt, while the original electrolyte removed from the cell comprises less than about 0.1M of the lithium containing salt.

In certain embodiments, at least the portion of the electrolyte is replaced after transferring the portion of the lithium from the auxiliary electrode to the negative electrode but prior to conducting the one or more formation cycles. In other embodiments, at least the portion of the electrolyte is replaced after conducting the one or more formation cycles. The method may involve replacing the auxiliary electrode with a replacement auxiliary electrode and the sealing the positive electrode, the negative electrode, and the replacement auxiliary electrode inside a cell case. The replacement auxiliary electrode includes a greater amount of lithium than the auxiliary electrode at the time of replacement. In certain embodiments, the method also involves, after sealing the positive electrode, the negative electrode, and the replacement auxiliary electrode inside the cell case, transferring additional lithium from the replacement auxiliary electrodes to the negative electrode.

Provided also is a lithium ion battery apparatus including a cell that has a negative electrode comprising a high-capacity active material, a positive electrode, and an auxiliary electrode in ionic communication with the negative electrode and the positive electrode. The lithium ion battery apparatus also includes control logic in electrical communication with the auxiliary electrode. The control logic may be configured to cut off discharge of the cell when the high-capacity active material in the negative electrode reaches a cut off lithiation level of at least about 500 mAh/g.

These and other aspects are described further below with reference to the figures.

### BRIEF DESCRIPTION OF THE DRAWINGS

FIG. 1 illustrates a plot of a typical galvanostatic profile for silicon in accordance with certain embodiments.

FIG. 2 illustrates a plot of an internal resistance of silicon nanowires as a function of their lithiation state in accordance with certain embodiments.

FIG. 3 is a schematic representation of a cell assembly with an auxiliary electrode in accordance with certain embodiments.

FIG. 4A illustrates a technique for fabricating and operating a cell assembly containing an auxiliary electrode in accordance with certain embodiments.

FIGS. 4B-4F and schematic illustrations of lithiation states of three electrodes at different stages of cell fabrication and operation in accordance with certain embodiments.

FIGS. 5A-B are top schematic views and a side schematic view of an illustrative electrode arrangement in accordance with certain embodiments.

FIGS. 6A-B are top schematic views and a perspective schematic view of an illustrative round wound cell in accordance with certain embodiments.

FIG. 7 is a top schematic view of an illustrative prismatic wound cell in accordance with certain embodiments.

FIGS. 8A-B is a top schematic view and a perspective schematic view of an illustrative stack of electrodes and separator sheets in accordance with certain embodiments.

FIG. 9 is a schematic cross-section view of an example of a wound cell in accordance with embodiments.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

### Introduction

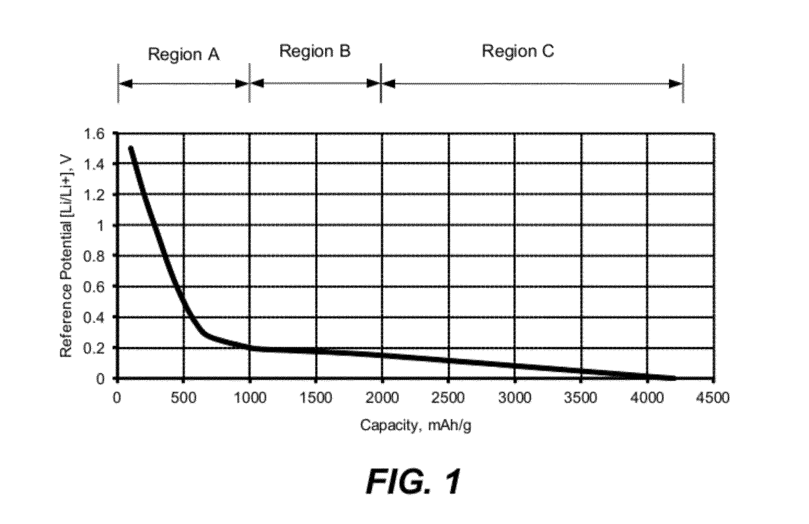

High capacity active materials, such as silicon, tin, and germanium, are very attractive for negative electrodes of rechargeable electrochemical cell applications, such as lithium ion cells. Theoretical capacities of these materials can greatly exceed that of conventional positive active materials, such as lithium cobalt oxide. As a result, rechargeable cells can be built with a negative electrode having a relative high capacity in comparison to the positive electrode. At the same time, it has been found that many high capacity active materials demonstrate better cycling performance when they are cycled within lithiation ranges that do not go to full delithiation of the high capacity active material and there is always some lithium retained in this active material. This finding will now be further explained with reference to FIG. 1.

FIG. 1 illustrates a typical galvanostatic profile for silicon, in accordance with certain embodiments. The profile indicates that lithium ions can be inserted into and removed from silicon at lower electrochemical potentials when some lithium is already present in silicon. The profile plot is conceptually divided into three regions. “Region A” corresponds to a low lithiation range, e.g., less than about 1000 mAh/g. In this range, the negative electrode containing silicon requires higher voltages, e.g., at least about 0.2V versus lithium, to drive lithium ions in and out of silicon or, more specifically, active materials structures of the negative electrode that contain silicon. These higher voltage requirements are not desirable from the power output perspective. Furthermore, some fraction of lithium becomes irreversibly trapped in silicon after initial cycling, such as being consumed during formation of a Solid Electrolyte Interphase (SEI) layer and other reasons. This trapped lithium cannot be extracted back from the silicon containing structure, regardless of the voltage applied to the negative electrode.

“Region B” corresponds to an intermediate lithiation range, e.g., between about 1000 mAh/g and 2000 mAh/g. In this region, the negative electrode is cycled between two partially lithiated states. As shown in the plot, the reference potential range is substantially lower in that range than in the low lithiation range, the Range A. Furthermore, the reference potential is rather constant in the intermediate lithiation range. In this range, silicon structures undergoes some metallurgical changes by accommodating and then releasing additional lithium atoms, however these changed are not as severe as in the more lithiated range.

“Region C” corresponds to a saturated lithiation range, where silicon containing active material structures of the negative electrode are lithiated close to the theoretical capacity of silicon on the higher (right) end of this range. While the reference potential range is even lower in this range than in the other two ranges, a high concentration of lithium in the active material structures may lead to fracturing of these structures, loses of electrical connections among fractured structures, and overall degradation of the negative electrode. Sometimes this phenomenon is referred to as a pulverization of silicon containing active material structures. A substantial capacity fade is experienced when silicon containing active material is cycled close to its theoretical capacity.

It has been found that silicon and other high capacity active materials may be cycled at some intermediate lithiation ranges with degrading active material structures and experiencing substantial voltage fluctuations. While operating a cell within such a range does not use a full lithiation capacity of its high capacity active material, the available capacity is still sufficient and, in fact, superior to conventionally used alternatives. For example, silicon containing structures cycled between 1000 mAh/g and 2000 mAh/g provide a capacity of 1000 mAh/g, while theoretical capacity of graphite is only 372 mAh/g and its practical capacity is even lower.

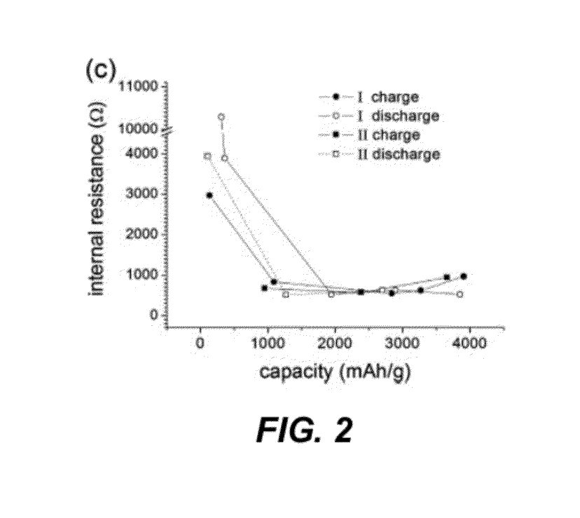

Furthermore, lithiation of silicon containing active material structures tends to increase their conductivity as more lithium is introduced into the active material. FIG. 2 illustrates four plots of an internal resistance of silicon nanowires as a function of their lithiation state, in accordance with certain embodiments. The plot shows significant drop in resistance when silicon nanowires are lithiated to about 1000 mAh/g in comparison to lower lithiation state. The resistance remains substantially the same at higher lithiation states. Another interesting observation is that the resistance increases when silicon nanowires are discharged back to lower lithiation states of less than 1000 mAh/g. Lower resistance is a desirable characteristic because silicon and other high capacity materials are relied upon to conduct electricity from lithiation sites to a current collector which may be spaced apart by a few nanometers or tens of micrometers depending on the configuration of active material structures and electrodes.

It should be noted that values shown in FIGS. 1 and 2 are for illustrative purposes only and should not be considered limiting to any embodiments described below. One having ordinary skills in the art would be able to determine optimal lower and higher lithiation levels of high capacity active materials based on characteristics of the active materials, such as conductivity, theoretical capacity, and swelling, configuration of the active materials structures, operating requirements of the cell, such as discharge rates, cycling performance, and other. For example, cells designed to have frequent charge-discharge cycles, such as in electrical vehicle or consumer electronic applications, may have a narrower intermediate lithiation range in order to preserve longevity of the cell. On the hand, cells designed for infrequent cycling but requiring higher capacities, such as some aerospace and medical device applications, may have a wider intermediate lithiation range to meet these different requirements.

At the same time, operating conventional electrochemical cells build with low capacity active materials, such as graphite, at intermediate lithiation ranges of the active material is difficult and inefficient. Not only such active materials have a substantially lower capacity than proposed higher capacity materials and shrinking their operating range will reduce this capacity even further but also these cells generally have no additional source of lithium. In conventional cell, lithium is supplied by a positive active material that includes other chemical elements. Typically, lithium accounts for only a small weight fraction of the positive active material, e.g., 4.4% in LiFePO₄, 7.1% in LiCoO₂, and 2.4% in LiV₃O₈. Continuously retaining some lithium in the negative electrode during cell cycling results in some positive active material remaining idle and unavailable for electrochemical work.

Novel electrochemical cell designs describe herein include an auxiliary electrode that is used as an additional source of lithium in order to bring the negative high capacity active material to its intermediate cycling range. The negative high capacity active material is then cycled within this intermediate cycling range by transferring lithium between positive and negative electrodes. The auxiliary electrode may be removed from the cell after initial stages of its fabrication or retained in the cell even during its operation. In certain embodiments, an auxiliary electrode is removed after electrochemically transferring at least a portion of its lithium to the negative electrode and, for example, prior to subsequent formation cycles. In other embodiments, an auxiliary electrode is removed from the cells after performing formation cycles. An initial auxiliary electrode may be replaced with a fresh auxiliary electrode that is retained in the cell during its subsequent operation. The new or original auxiliary electrode may be retained in the cell to provide additional lithium during operation of the cell. For example, some additional lithium may be irreversibly trapped in the positive and/or negative electrode after initial cycling. The auxiliary electrode is used to compensate these losses. In certain embodiments, an auxiliary electrode may be used in an operational cell for precisely monitoring the voltage (vs. lithium) of each electrode.

It has been found that high capacity active materials tend to irreversibly trap substantial amounts of lithium to form SEI layers, and this lithium becomes unavailable for further cycling. For example, during initial cycling of lithium ion cells, which is sometimes referred to as formation cycling, some electrolyte components may decompose after being exposed to a relative high voltage boundary at the negative electrode surface and form an SEI layer. It has been reported that an SEI layer formed on a silicon electrode contains as much as 20% of lithium. The SEI layer formation has been viewed as one of the main contributors to the capacity fading in silicon based lithium ion cells. Lithium loss and corresponding capacity fade is much more prominent and severe in electrochemical cells having higher capacity electrodes than in conventional graphite based electrodes. Specifically, lithium amounts lost to SEI layer formation depend in part on the negative electrode surface area exposed to the electrolyte. This area tends to be much larges for electrodes with high capacity active materials than for conventional electrodes. High capacity active materials can be formed into nanostructures, e.g., to overcome mechanical degradation as further explained in U.S. patent application Ser. No. 12/437,529 filed on May 7, 2009, which is incorporated by reference herein in its entirety for the purpose of describing nanostructured active materials. For example, an active layer containing 20 μm long nanowires that are 0.1 μm in diameter and arranged with 25% density has a 200 times greater surface area than that of a flat substrate area used to form this layer. Furthermore, lithium looses often continue throughout subsequent cycles in cells with high capacity negative active materials that subject SEI layers to severe stresses caused by active material swelling.

Furthermore, it has been also found that performance of electrochemical cells with high capacity active materials can be substantially improved if lithiation states of each electrode are monitored and adjusted individually. In conventional cells, lithiation states are estimated by measuring an overall cell voltage, i.e., a voltage between the positive and negative electrodes. However, this technique is not precise. Electrode potentials tend to drift due to chemical and structural changes in the electrodes, such as formation of an SEI layer and micro-shorts, while the overall cell voltage (i.e., the difference between these potentials) may remain the same. Measuring individual potentials of each electrode with reference to lithium is important for optimizing cell performance. Auxiliary electrodes described herein can be used as such reference electrodes.

While references are generally made to lithiation and lithium ion cells, it should be understood that the described features are also applicable to other types of cells. For example, sodium may be used instead of lithium in some types of cells.

### Cell Structure and Auxiliary Electrode Examples

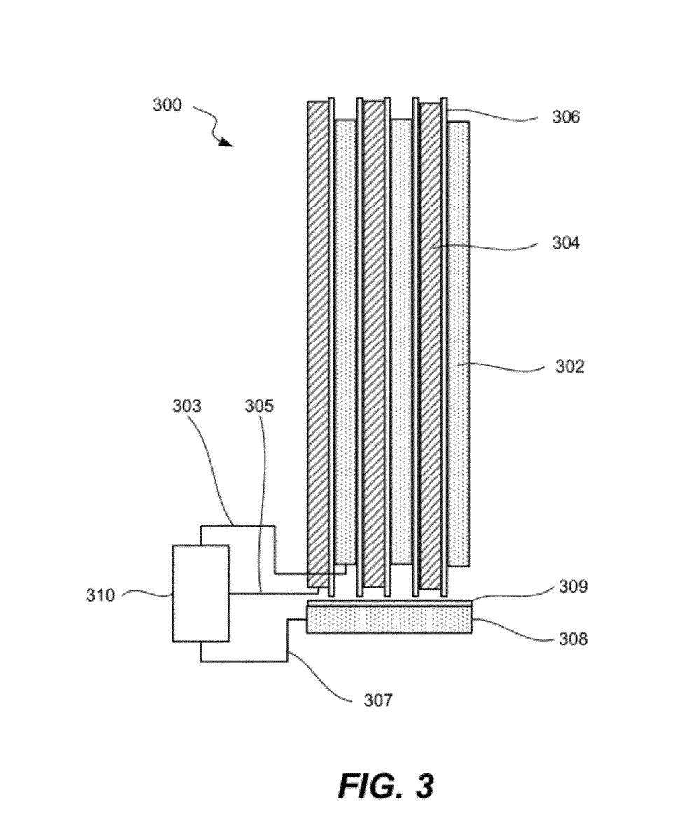

FIG. 3 illustrates a schematic representation of a cell assembly 300 having an auxiliary electrode 308, in accordance with certain embodiments. The assembly 300 includes at least one positive electrode 302, at least one negative electrode 304, and one or more separator sheets 306 positioned between these electrodes and providing mechanical and electrical separation of the these electrode. Both positive and negative electrodes may include a conductive current collector and an active material electrically and mechanically coupled to the current collector. Examples of positive active materials include Li (M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn₁₋ₓ)O₂, Li(Al_{X}Mn_{1-X})O₂), Li(Co_{X}M_{1-X})O₂, where M is a metal, (e.g. Li(Co_{X}Ni_{1-X})O₂ and Li(Co_{X}Fe_{1-X})O₂), Li_{1-W}(Mn_{X}Ni_{Y}Co_{Z})O₂, (e.g. Li(Co_{X}Mn_{Y}Ni_{(1-x-Y)})O₂, Li(Mn_{1/3}Ni_{1/3}Co_{1/3})O₂, Li(Mn_{1/3}Ni_{1/3}xMg_{X})O2, Li(Mn_{0.4}Ni_{0.4}Co_{0.2})O₂, Li(Mn_{0.1}Ni_{0.1}Co_{0.8})O₂, Li_{1-W}(Mn_{X}Ni_{X}Co_{1-2X})O₂, Li_{1-W}(Mn_{X}Ni_{Y}CoAl_{W})O₂, Li_{1-W}(Ni_{X}Co_{Y}Al_{Z})O₂ (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X-Y}Mn_{Y}Cr_{2-X})O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn_{1-X}Al_{X}O₄, LiNi_{0.5}Ti_{0.5}O₄, Li_{1.05}Al_{0.1}Mn_{1.85}O_{4-z}F_{z}, Li₂MnO₃) Li_{X}V_{Y}O_{Z}, e.g. LiV₃O₈, LiV₂O₅, and LiV₆O₁₃. One group of positive active materials may be presented as LiMPO4, where M is a metal. Lithium iron phosphate (LiFePO₄) is one example in this group. Other examples include LiM_{X}M″_{1-X}PO₄ where M′ and M″ are different metals, LiFe_{X}M_{1-X}PO₄, where M is a metal (e.g., LiVOPO₄Li₃V₂(PO₄)₃), LiMPO₄, where M is a metal such as iron or vanadium. Further, a positive electrode may include a secondary active material to improve charge and discharge capacity, such as V₆O₁₃, V₂O₅, V₃O₈, MoO₃, TiS₂, WO₂, MoO₂, and RuO₂. Additional examples of positive active materials are described in U.S. patent application Ser. No. 13/004,737, entitled “VARIABLE CAPACITY CELL ASSEMBLY,” filed on Jan. 11, 2011 (Attorney Docket AMPRP010US), which is incorporated herein by reference in its entirety for purposes of describing positive active materials.

A negative electrode includes one or more high capacity active materials, such as silicon, germanium, tin, tin oxide, titanium oxide, carbon, a variety of metal hydrides (e.g., MgH₂), silicides, phosphides, and nitrides. Other examples of active materials and their combinations include: carbon-silicon combinations (e.g., carbon-coated silicon, silicon-coated carbon, carbon doped with silicon, silicon doped with carbon, and alloys including carbon and silicon), carbon-germanium combinations (e.g., carbon-coated germanium, germanium-coated carbon, carbon doped with germanium, and germanium doped with carbon), and carbon-tin combinations (e.g., carbon-coated tin, tin-coated carbon, carbon doped with tin, tin doped with carbon, and silicon mixed with oxides. High capacity active materials are generally defined as active materials with theoretical lithiation capacities of at least about 700 mAh/g. In certain embodiments, a portion of high capacity active materials in the active layer is at least about 50%, or at least about 75%, or at least about 80%, or at least about 85%, or at least about 90% relative to the total amount of the negative active materials. Other materials in the active layer may include other active materials, conductive additives, binder, and alike. Doped and non-stoichiometric variations of these materials may be used as well. In certain embodiments, active materials may be arranged in core-shell structures with other active or inactive materials. Core materials are typically different from shell materials, and two adjacent cores typically have different materials. However, in certain embodiments, materials may only be different based on their morphological structure (e.g., a crystalline silicon core and an amorphous silicon shell or vice versa). In certain embodiments, a core includes carbon while a shell includes silicon. In other embodiments, a core includes silicon while a shell includes carbon. In certain embodiments, the lithium concentration in the core is on average greater that the lithium concentration in the shell. In other embodiments, the lithium concentration in the core is on average less than the lithium concentration in the shell.

The high capacity active material may be in various forms, such as uniform thin layer, particles bound to the substrate with the polymeric binder, substrate rooted nanostructures, and other forms and structures. In certain embodiments, the high capacity active materials are substrate rooted nanostructures. These nanostructures are physically and conductively attached to the substrate, which may serve as a current collector for the electrode. Nanostructures may be rooted to the substrate at random locations on the structure's profiles (randomly rooted), or rooted preferentially at some particular location on the nanostructures (non-randomly rooted). Example of non-randomly rooted nanostructures include terminally rooted nanostructures (e.g., nanowires and nanorods) and medially rooted nanostructures preferentially affixed to the substrate at medial positions (rather than a terminal position) further described in U.S. patent application Ser. No. 12/437,529 filed on May 7, 2009, which is incorporated by reference herein in its entirety for the purpose of describing nanostructures.

In certain embodiments, high capacity active materials are formed as a thin layer over a conductive template extending from the surface of the conductive substrate. Some examples of templates include nanowires, nanotubes, particles, and films. In certain embodiments, templates are silicide nanowires, more specifically, silicide nanowires that are growth-rooted to the conductive substrate. Various examples of templates are described in U.S. patent application Ser. No. 13/039,031, entitled “TEMPLATE ELECTRODE STRUCTURES FOR DEPOSITING ACTIVE MATERIALS,” filed on Mar. 2, 2011 (Attorney Docket No. AMPRP012US) and U.S. patent application Ser. No. 13/114,413, entitled “MULTIDIMENSIONAL ELECTROCHEMICALLY ACTIVE STRUCTURES FOR BATTERY ELECTRODES,” filed on May 24, 2011 (Attorney Docket No. AMPRP014US), which are incorporated herein by reference in their entireties for all purposes.

Examples of separators include a fabric woven from fluoro-polymeric fibers of polyethylenetetrafluoroethylene (PETFE) and polyethylenechlorotrifluoroethylene used either by itself or laminated with a fluoropolymeric microporous film. Moreover, a separator materials may include, polystyrenes, polyvinyl chlorides polypropylene, polyethylene (including LDPE, LLDPE, HDPE, and ultra high molecular weight polyethylene), polyamides, polyimides, polyacrylics, polyacetals, polycarbonates, polyesters, polyetherimides, polyimides, polyketones, polyphenylene ethers, polyphenylene sulfides, polymethylpentene, polysulfones non-woven glass, glass fiber materials, ceramics, a polypropylene membrane commercially available under the designation CELGARD from Celanese Plastic Company, Inc. in Charlotte, N.C., USA, as well as Asahi Chemical Industry Co. in Tokyo, Japan, Tonen Corporation, in Tokyo, Japan, Ube Industries in Tokyo, Japan, and Nitto Denko K.K. in Osaka, Japan. In one embodiment, a separator includes copolymers of any of the foregoing, and mixtures thereof.

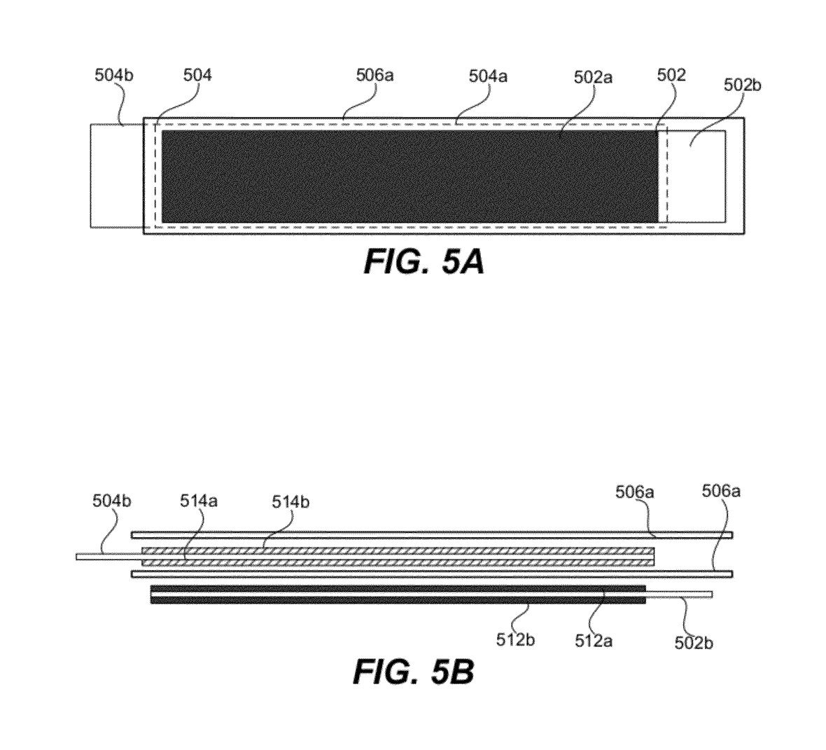

Two common arrangements of the electrodes in electrochemical cells are wound and stacked. These arrangements are further described with reference to FIGS. 6A-9. The goal of these arrangements is to position and align the surfaces of the two electrodes surfaces as close as possible to each other to provide efficient ionic transfer between the two electrodes but without causing an electrical short between the electrodes. Close positioning allows lithium ions to travel more rapidly and more directly between the two electrodes leading to better performance. Both of these arrangements have at least top and bottom surfaces that may be used for positioning auxiliary electrodes. For example, a jelly roll may be formed as a cylinder that has two end surfaces formed by exposed edges of the two electrodes and separator. The stack arrangement has additional side edges, i.e., four exposed edges of the electrodes and separator. Auxiliary electrode 308 may be positioned in close proximity to these surfaces formed by exposed edges to ensure sufficient ionic communication between auxiliary electrode 308 and at least and negative electrodes 304. However, it may be desirable to have good ionic communication among all three electrodes. In certain embodiments, auxiliary electrode 308 is separated from other electrodes by a separator sheet 309 as, for example, shown in FIG. 3, to avoid an internal electrical short between auxiliary electrode 308 and positive electrode 302 or negative electrode 304. Other positions of auxiliary electrodes with respect to positive and negative electrodes are possible. For example, an auxiliary electrode may be positioned in the center of the jelly roll similar to a mandrel during winding of the jelly roll. In another example, an auxiliary electrode may be positioned as a sleeve around the jelly roll or a stack. Some of these examples are further described below with reference to FIGS. 6A-9. Some of these positions may impede ionic mobility from the auxiliary electrodes and the process of initial transfer of lithium from the auxiliary electrodes to negative electrodes may need to be performed at conditions that compensate for this lower mobility. For example, the process may be performed at elevated temperatures and/or slower rates than typical operating conditions of the cells and even than formation cycling.

An auxiliary electrode may contain at least some lithium or be made entirely from lithium. Lithium containing auxiliary electrodes may be made from one or more of the following materials: elemental lithium (e.g., particles, foils, wire), lithium-tin, lithium-germanium, lithium silicide, lithium carbide, lithium oxide, lithium nitride, and certain lithium salts. Amounts of lithium in the auxiliary electrode relative to the maximum operating capacity of the negative electrode may be at least about 5%, at least about 10%, at least about 25%, or even at least about 50%. In certain embodiments, an auxiliary electrode is not used a source of lithium and can be made from materials that do not contain lithium, such as platinum and/or gold.

An auxiliary electrode can be formed as a foil or a wire. In certain embodiments, an auxiliary electrode is part of other cell components, such as a cell cap or a cell can. For example, a cap that is used to seal a can may have an auxiliary electrode insert in it. A conductive cap (e.g., an aluminum cap) may also be used to provide an electrical communication to the auxiliary electrode. As mentioned above, an auxiliary electrode may be a permanent structure in the cell and remain in the cell after its fabrication. Alternatively, an auxiliary electrode may be a temporary structure in the cell and be removed from the cell during its fabrication, e.g., during or after formation of the cell and prior to the final sealing of the cell. When a temporary auxiliary electrode is used, it is positioned near the opening of the cell assembly in order to easily remove this electrode from the assembly in later operations. For example, an auxiliary electrode may be positioned on a temporary cover placed over the can containing a stack or a jellyroll. This temporary assembly may be used during formation after which the temporary cover with a partially consumed auxiliary electrode is removed and replaced with the permanent cover.

An auxiliary electrode has a connector tab 307 electrically connecting it to an auxiliary terminal of the cell. Overall, a cell containing an auxiliary may have three connector tabs for each one of its electrodes. As shown in FIG. 3A, cell assembly 300 includes a positive connector tab 303 for connecting the positive terminal to the positive electrode 302, a negative connector tab 305 for connecting the negative terminal to the negative electrode 304, and an auxiliary connector tab 307 for connecting the auxiliary terminal to the auxiliary electrode 308. These terminals are used for controlling the voltages between the terminals and to initiate and control lithium transfer among the electrodes. For example, the negative and auxiliary terminals may be interconnected in a controlled manner to transfer at least a portion of lithium from the auxiliary electrode to the negative electrode. During the process, the electrical current between the negative and auxiliary terminals is controlled to ensure a proper ionic flow. Furthermore, the voltage between the negative and auxiliary terminals is controlled to determine the lithiation level of the negative electrode.

In certain embodiments, when a temporary auxiliary electrode is used, this electrode may temporary share a positive terminal with the positive electrode. The auxiliary electrode is then removed or disconnected from the positive terminal prior to formation cycling. In certain embodiments, a cell assembly includes two or more auxiliary electrodes. For example, a jelly roll may have two auxiliary electrodes positioned next to each end of the jelly roll. Similarly, a stack may have auxiliary electrodes positioned along two, three, or all four edges of the stack.

A portion of lithium or substantially all lithium of the auxiliary electrode may be consumed during cell operation (e.g., during pre-lithiation and/or subsequent cycling). It has been estimated that pre-lithiating one gram of silicon to about 1000 mAh/g requires at least about one gram of lithium metal. This significant consumption of lithium may create a gap between auxiliary and working electrodes and interfere with further ionic transfer. A cell assembly may provide a mechanism to ensure that the auxiliary electrode stays in sufficient ionic communication with the working electrodes during the cell entire operation. For example, a cell may have a spring mechanism to push the auxiliary electrode towards the stack or jelly-roll. In the same or other embodiments, thinning of the auxiliary electrode may be compensated by thickening of the negative electrode that may occur during pre-lithiation and/or cycling.

Cell assembly 300 may also include a cell management circuit 310 that is individually coupled to positive electrode 302, negative electrode 304, and auxiliary electrode 308. This allows cell management circuit 310 to individually monitor reference voltages of both working electrodes, i.e., positive electrode 302 and negative electrode 304. For purposes of this document, a voltage between the positive and auxiliary electrodes is referred to as a positive reference electrode voltage or a positive electrode voltage. A voltage between the negative and auxiliary electrodes is referred to as a negative reference electrode voltage or a negative electrode voltage. Finally, a voltage between the positive and negative electrodes is referred to as an overall cell voltage or a cell voltage. As mentioned above, monitoring individual electrode voltages may be used to improve cycling performance of the cell.

In certain embodiments, a cell management circuit (more generally “control logic”) may be a part a larger battery pack, a battery charger, an electrical circuit powered by the battery (e.g., power management circuit of a cell phone or a laptop). Precise control of lithiation states may be also used to improve safety characteristics of the cells, e.g., to prevent overcharges, deep discharges, run-away conditions.

### Fabrication and Cycling Examples

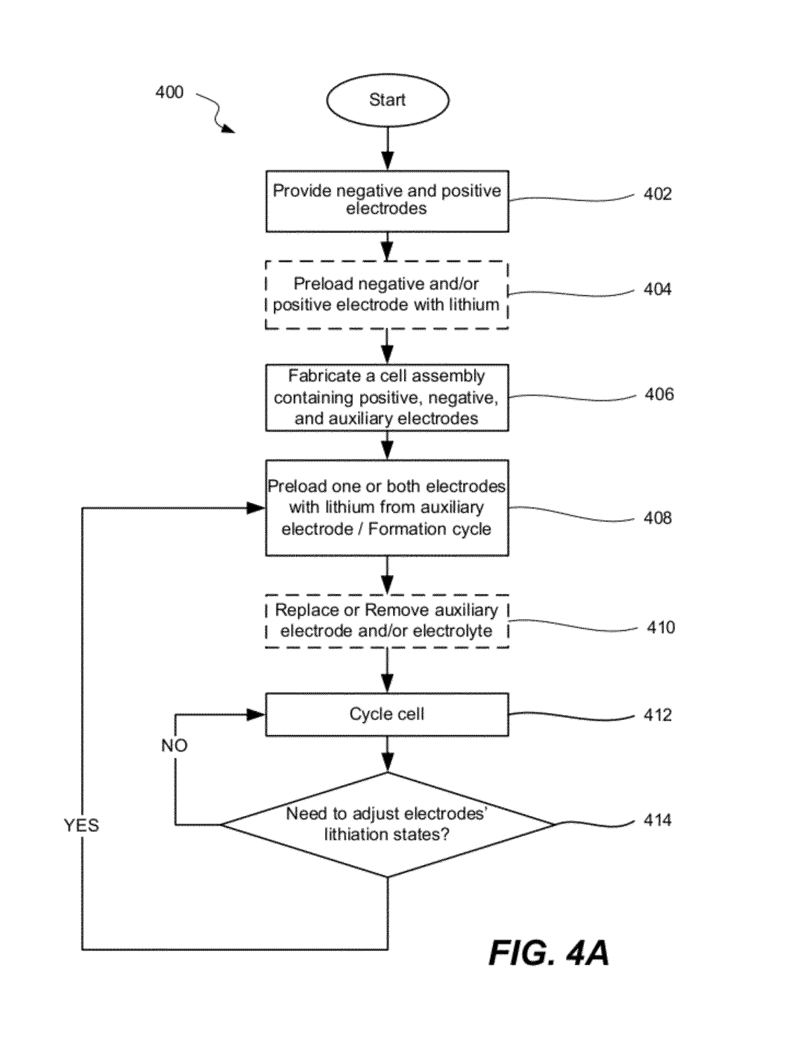

FIG. 4A illustrates a process 400 for fabricating and operating a cell assembly containing an auxiliary electrode in accordance with certain embodiments. At an operation 402, positive and negative electrodes are provided or received for use in assembling an electrode. Various examples of these electrodes are described above. Process 400 may continue with an optional operation 404, during which the positive and/or negative electrodes may be preloaded with lithium prior to assembling these electrodes into a stack, jelly roll, or other final electrode arrangement. Some examples of preloading techniques are described in U.S. patent application Ser. No. 12/944,593, entitled “PRELOADING LITHIUM ION CELL COMPONENTS WITH LITHIUM,” filed on Nov. 11, 2010 (Attorney Docket AMPRP006US), which is incorporated herein by reference in its entirety for purposes of describing lithium preloading. In one example, lithium may be mechanically deposited directly onto the electrode surface in a form of nanoparticles (with a diameter of approximately 10-50 nanometers and a specific surface area of about 30-50 m²/g, e.g., supplied by American Elements in Los Angeles, Calif.), foil (e.g., supplied by American Elements in Los Angeles, Calif.). Other examples include electrolytic deposition of lithium. Optional operation 404 should be distinguished from pre-lithiating operation 408 described below, which is performed on a cell assembly containing both working electrodes and during which lithium is supplied by the auxiliary electrode to one or both working electrodes. To the contrary, in various embodiments, lithium preloading during optional operation 404 is performed on individual electrodes that are not yet arranged together into a cell assembly.

Operations 404 and 408 may be used to insert or otherwise provide additional lithium (i.e., in addition to lithium supplied on a positive electrode) on either positive or negative electrodes or both. In certain embodiments, the additional lithium provided in operation 404 corresponds to between about 5% and 50% of the negative active material's theoretical capacity or, more specifically, to between about 5% and 25% of that capacity. Typically, a total amount of lithium available in the cell on all three electrodes exceeds the positive active material's theoretical capacity, e.g., by at least about 5% or, more specifically, by at least about 10%, or at least about 25%. In the same or other embodiments, the capacity of the negative electrode is greater than the capacity of the positive electrode by at least about 10% or, more specifically, at least about 25%. The higher capacity of the negative electrode allows maintaining this electrode in at least partially lithiated stated at any point during cycling. At the same time, the positive electrode may go to a substantially complete delithiation and substantially complete lithiation during cycling.

Lithiation states may be also expressed in terms of cut-off voltages and actual lithiation capacity. In certain embodiments, silicon is used as a high capacity active material and is pre-lithiated (before cycling) to reach a potential less than about 200 mV, or more particularly to less than about 100 mV, versus a lithium metal electrode. The amounts of lithium provided in the pre-lithiation process are further described below.

At an operation 406, a cell assembly containing positive, negative, and auxiliary electrodes is fabricated. Various examples of such assemblies are described elsewhere in this document, for example, with reference to FIGS. 3 and 5A-9. The cell assembly also includes an electrolyte to provide an ionic communication between the positive, negative, and auxiliary electrodes. The electrolyte provided in the cell assembly during operation 406 may be different from electrolyte that used in the fully fabricated cell, e.g., the cell cycled during operation 412. In other words, the cell assembly may be initial assembled with one electrolyte, i.e., the initial electrolyte, which is later replaced for or modified into a new electrolyte, the new electrolyte. The initial electrolyte may have a lower salt concentration, e.g., 0.01M-0.1M, than the new electrolyte, e.g., 1.0M. One example of the salt is LiPF6, while other examples are listed below. In certain embodiment, a new electrolyte includes at least about 0.5M of a lithium containing salt, while the initial electrolyte includes less than about 0.1M of the lithium containing salt. In the same or other embodiments, the new electrolyte has a higher conductivity that the initial electrolyte. The lower conductivity of the initial electrolyte may have help to have a better control over ionic mobility of lithium during its transfer from the auxiliary electrode to the negative electrode. As mentioned above, the design of the cell may be such that ionic mobility between these two electrodes may not be as high as between the positive and negative electrodes. Therefore, transfer of lithium from the auxiliary electrode to the negative electrode may be performed in a lower conductivity electrolyte (than during past-fabrication operation of the cell) to ensure more uniform distribution of lithium on the negative electrode. In certain embodiments, the same electrolyte formulation is used through the fabrication of the cell and later during operation of the cell. However, more electrolyte may be present in the cell enclosure during at least transfer of lithium from the auxiliary electrode to the negative electrode than during operation of the cell. Some of this initial electrolyte may be removed before or after formation cycling.

In certain embodiments, when an auxiliary electrode is not later replaced or removed and the initial electrolyte remains in the cell unchanged, the cell may be permanently sealed during operation 406. In other embodiments, a cell assembly fabricated in 406 is not permanently sealed and allows, for example, subsequent removal and/or replacement of the auxiliary electrode and/or subsequent removal and/or replacement of the initial electrolyte.

At 408, the negative electrode is preloaded with lithium supplied by the auxiliary electrode. As mentioned above, this operation may be performed in addition to optional operation 404 or instead of it. In certain embodiments, a negative electrode is pre-lithiated to at least about 10% or, more particularly, to at least about 15%, or to at least about 20%, or even at least about 25% of its theoretical capacity. In certain embodiments, optimal lithiation levels are determined, at least in part, by galvanostatic charge-discharge profiles for particular active materials and/or expected SEI losses for this type of materials and electrode structures. Other factors are listed above. In particular embodiments, a silicon based negative electrode is pre-lithiated to at least about 200 mAh/g or, more particularly, to at least about 5000 mAh/g or even to at least about 1000 mAh/g. In general, a negative electrode cut-off voltage may be used to monitor pre-lithiation levels, which may be about 200 mV or less, or, more particularly, about 150 mV or less, or even about 100 mV or less, for silicon based negative electrodes. Pre-lithiation may involve establishing an external electrical connection between the negative and auxiliary electrodes such that the pre-lithiation rate is precisely controlled, e.g., less than about C/10, or more particularly less than about C/100 and even less than about C/1000. In certain embodiments, the rate is between about C/10 and C/100. The same rate may be later using during formation of the cell.

At least a part of an SEI layer may form during the pre-lithiation operation. As such, this operation may be performed while other process conditions (e.g., temperature) are controlled to achieve desirable SEI layer characteristics (e.g., permeability, elasticity). For example, pre-lithiation may be performed at a temperature of between about 40° C. and 80° C. or, more particularly, at a temperature of between about 50° C. and 60° C. In certain embodiments, pre-lithiation is performed at 20-60° C. In other embodiments, pre-lithiation is performed at a typical operating temperature of the cell (e.g., at a room temperature). The same temperature may be used during formation operation. Alternatively, formation cycling may be performed at different temperatures.

In certain embodiments, operation 408 may also involve one or more formation cycles. During formation cycles lithium ions are transferred between positive and negative electrodes. Formation may be performed before, after, or in combination with pre-lithiation. For example, operation 408 may start with supplying lithium ions to the negative electrode from the positive electrode and then continue with supplying lithium ions to the negative electrode form the auxiliary electrode. Alternatively, the negative electrode may be lithiated simultaneously by ions supplied from the positive and negative electrodes. A specific voltage control and cell designs may be implemented to achieve various ion transfer configurations.

In certain embodiments, pre-lithiation can consume a large part of the auxiliary electrode. In further embodiments, the original auxiliary electrode is consumed and then replaced with a new “replacement” auxiliary electrode in operation 410. A “replacement” auxiliary electrode may, in certain embodiments, have larger amounts of lithium than the discarded original electrode. In other embodiments, the original electrode is removed from the cell assembly and no replacement electrode is provided. In other words, an auxiliary is only present temporary in the cell assembly during operations 406-410 and is not present in a fully fabricated cell. In yet other embodiments, the auxiliary electrode is not removed, replaced, or otherwise changed or modified during operation 410.

Operation 410 may involve modifying the initial electrolyte in the cell by changing its amount and/or formulation ads described above. These changed to the initial electrolyte may be performed in addition or instead of changes to the auxiliary electrode. Operation 410 may involve outgassing of the cell assembly prior to the final sealing of the cell assembly. Outgassing may be used to provide better distribution of the electrolyte in the cell. In other embodiments, operation is not performed and the cell assembly has a final seal established during operation 406.

The process 400 may continue with operation 412 involving cycling the cell at typical operating conditions. During cycling electrode lithiation states' may continuously (e.g., during or after every cycle) or repeatedly (e.g., after a predetermined number of cycles) be monitored (block 414). For example, a cell management circuit may be used to monitor a positive electrode voltage and negative electrode voltage independently. The lithiation states (and voltages) may be adjusted accordingly by supplying or removing lithium from electrodes by repeating operation 408. As described above, lithium may be irreversibly consumed by positive and negative electrodes for, e.g., SEI layer, and additional lithium may need to be supplied throughout cycling to further extend the cycle life of the cell.

An idealized representation of the lithium present in the three electrodes at various stages in the life of a cell is schematically illustrated in FIGS. 4B-4F. A one dimensional vertical representation of electrode capacity for lithium ions is shown, with the heights of the bars in FIGS. 4B-F representing the total theoretical capacity of the various electrodes. Capacities of auxiliary and positive electrodes are shown to be less than one third that of the negative electrode. The diagonally filled areas in the bars represent the fractions of the electrode capacities occupied by lithium. As described above, the process involves fabricating a cell assembly containing the three electrodes. FIG. 4B is a schematic illustration of the lithium distribution in a cell during this fabrication operation and before any lithium is exchanged between the three electrodes. All lithium in the cell is located on the auxiliary and positive electrodes as shown with the two dashed areas. It should be noted that some lithium may be introduced into the negative electrode prior to fabrication, e.g., during optional operation 404 described above in the context of FIG. 4A. In this case, some filled area would also be present on the negative electrode.

As explained, the fabrication process may then continue with pre-lithiating the negative electrode using the auxiliary electrode. FIG. 4C is a schematic illustration of the lithium distribution after performing this initial pre-lithiation. Some lithium (represented by the sum of areas “B” and “D”) was transferred from the auxiliary electrode to the negative electrode to provide a baseline level of lithium for subsequent cycling during normal operation. As described above, this baseline level of lithium may be needed to establish the cycling range of the negative electrode within area “A” of FIG. 4C, i.e., above some predetermined partially lithiated baseline range. Area “B” represents a reversible capacity of the negative electrode, while area “D” represents an irreversible capacity of this electrode resulting from any of various irreversible processes. Examples of such irreversible processes include SEI layer formation and pulverization of the silicon electrode during volumetric changes encountered during cycling, as further described below. It should be noted that FIG. 4C also represents an initial discharge state of the cell. The cell may be then charged. FIG. 4D is a schematic illustration of the lithium distribution in the charged cell. Substantially all lithium is transferred from the positive electrode (a shaded area in FIG. 4C and a blank area in FIG. 4D corresponding to the positive electrode) and is now present on the negative electrode as an additional shaded area “A.” The auxiliary electrode may not participate in this charge-discharge cycle. As such, there may be no changes to lithium content in the auxiliary electrode (and its shaded area in FIGS. 4C and 4D). The cycling may continue, during which the distribution of lithium repeatedly changes between two states illustrated in FIGS. 4C and 4D.

Cycling may cause some additional increase in the irreversible capacity. FIG. 4E is a schematic illustration of the lithium distribution in a charged cell with a slightly greater irreversible capacity represented by area “D*”. This higher irreversible capacity range causes the lithiation cycling range (area “A*”) to shift away from the optimal range (area “A”). As can be seen from FIG. 4E, lithium supplied by the positive electrode is now not sufficient to cover the entire optimal range because some additional lithium was lost to the irreversible capacity (the difference between areas “D*” in FIG. 4E and “D” in FIG. 4D). In order to bring the negative electrode cycling back within its optimal range, some additional lithium is needed on the negative electrode and needs to be transferred from somewhere. All lithium from the positive electrode is used for cycling. However, the auxiliary electrode can be used to supply additional lithium at one or more times during the normal operational life of the cell. As shown in FIG. 4E, some lithium is still present on the auxiliary electrode and another pre-lithiation cycle may be performed to transfer this lithium to the negative electrode. FIG. 4F is a schematic illustration of the lithium distribution in a charged cell after performing this additional pre-lithiation. In this state, the negative electrode is brought back to the optimal cycling range.

### Cell Arrangement Examples

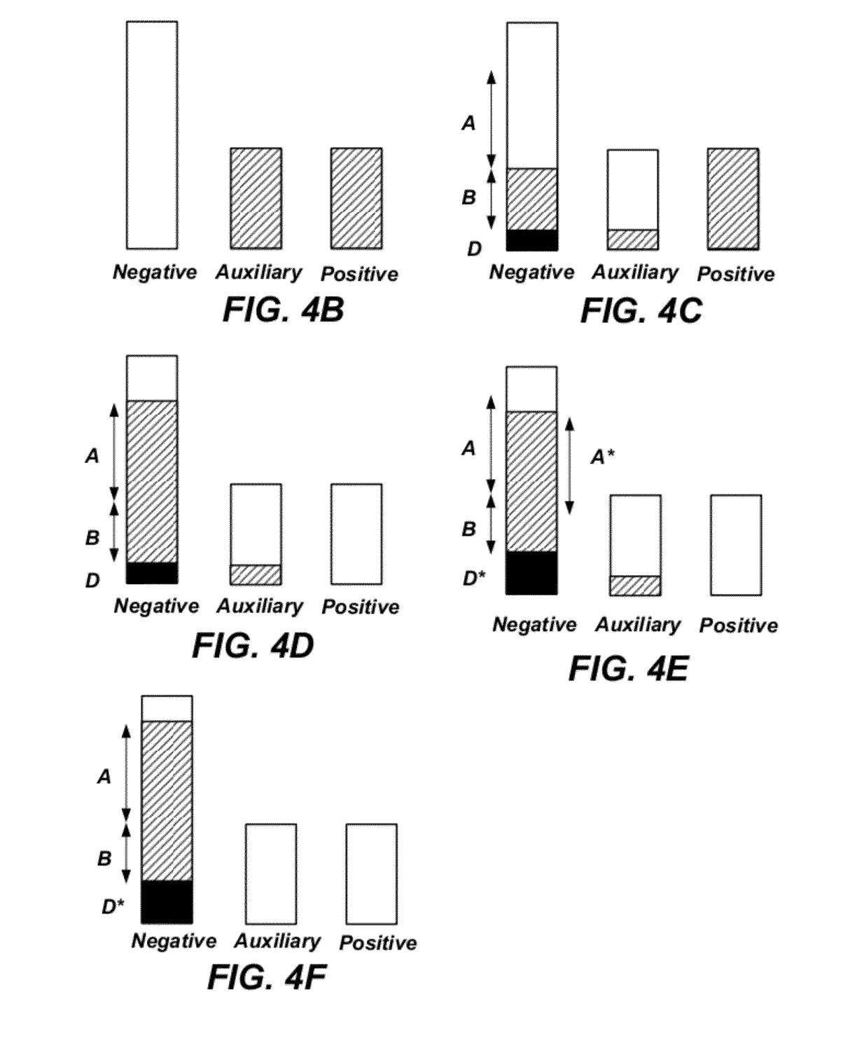

FIG. 5A illustrates a side view of an aligned stack including a positive electrode 502, a negative electrode 504, and two sheets of the separator 506a and 506b in accordance with certain embodiments. The positive electrode 502 may have a positive active layer 502a and a positive uncoated substrate portion 502b. Similarly, the negative electrode 504 may have a negative active layer 504a and a negative uncoated substrate portion 504b. In many embodiments, the exposed area of the negative active layer 504a is slightly larger that the exposed area of the positive active layer 502a to ensure trapping of the lithium ions released from the positive active layer 502a by intercalation material of the negative active layer 504a. In one embodiment, the negative active layer 504a extends at least between about 0.25 and 5 mm beyond the positive active layer 502a in one or more directions (typically all directions). In a more specific embodiment, the negative layer extends beyond the positive layer by between about 1 and 2 mm in one or more directions. In certain embodiments, the edges of the separator sheets 506a and 506b extend beyond the outer edges of at least the negative active layer 504a to provide electronic insulation of the electrode from the other battery components. The positive uncoated portion 502b may be used for connecting to the positive terminal and may extend beyond negative electrode 504 and/or the separator sheets 506a and 506b. Likewise, the negative uncoated portion 504b may be used for connecting to the negative terminal and may extend beyond positive electrode 502 and/or the separator sheets 506a and 506b. This arrangement of positive electrode 502 and negative electrode 504 may be later formed into a jelly roll by forming a round serpentine shape or stacked with other similar pair into an electrode stacks.

FIG. 5B illustrates a top view of the aligned stack. The positive electrode 502 is shown with two positive active layers 512a and 512b on opposite sides of the flat positive current collector 502b. Similarly, the negative electrode 504 is shown with two negative active layer 514a and 514b on opposite sides of the flat negative current collector. Any gaps between the positive active layer 512a, its corresponding separator sheet 506a, and the corresponding negative active layer 514a are usually minimal to non-existent, especially after the first cycle of the cell. The electrodes and the separators are either tightly would together in a jelly roll or are positioned in a stack that is then inserted into a tight case. The electrodes and the separator tend to swell inside the case after the electrolyte is introduced and the first cycles remove any gaps or dry areas as lithium ions cycle the two electrodes and through the separator.

A wound design is a common arrangement. Long and narrow electrodes are wound together with two sheets of separator into a sub-assembly, sometimes referred to as a jellyroll, shaped and sized according to the internal dimensions of a curved, often cylindrical, case. FIG. 6A shows a top view of a jelly roll comprising a positive electrode 606 and a negative electrode 604. The white spaces between the electrodes represent the separator sheets. The jelly roll is inserted into a case 602. In some embodiments, the jellyroll may have a mandrel 608 inserted in the center that establishes an initial winding diameter and prevents the inner winds from occupying the center axial region. Mandrel 608 may include an auxiliary electrode that may remain in the center of the jelly roll or be removed in later operation. In the same or other embodiments, an auxiliary electrode may be positioned between the jelly roll and case, the location schematically illustrated with a dashed line 605.

FIG. 6B is a schematic perspective view of the jelly roll in FIG. 6A with a positive tab 612 and a negative tab 614 extending from the jelly roll. These tabs are used for making electrical connections to the positive and negative terminals of the cell assembly. The tabs may be welded to the uncoated portions of the electrode substrates. FIG. 6B also illustrate an auxiliary electrode 615 positioned on the bottom of the jelly roll. Auxiliary electrode 615 is shown with its own tab 616 for making an electrical connection to the auxiliary terminal of the cell assembly.

The length and width of the electrodes depend on the overall dimensions of the cell and thicknesses of active layers and current collector. For example, a conventional 18650 cell with 18 mm diameter and 65 mm length may have electrodes that are between about 300 and 1000 mm long. Shorter electrodes corresponding to low rate/higher capacity applications are thicker and have fewer winds.

A cylindrical design may be desirable for some lithium ion cells because the electrodes swell during cycling and exert pressure on the casing. A round casing may be made sufficiently thin and still maintain sufficient pressure. Prismatic cells may be similarly wound, but their case may bend along the longer sides from the internal pressure. Moreover, the pressure may not be even within different parts of the cells and the corners of the prismatic cell may be left empty. Empty pockets may not be desirable within the lithium ions cells because electrodes tend to be unevenly pushed into these pockets during electrode swelling. Moreover, the electrolyte may aggregate and leave dry areas between the electrodes in the pockets negative effecting lithium ion transport between the electrodes. Nevertheless, for certain applications, such as those dictated by rectangular form factors, prismatic cells are appropriate. In some embodiments, prismatic cells employ stacks rectangular electrodes and separator sheets to avoid some of the difficulties encountered with wound prismatic cells.

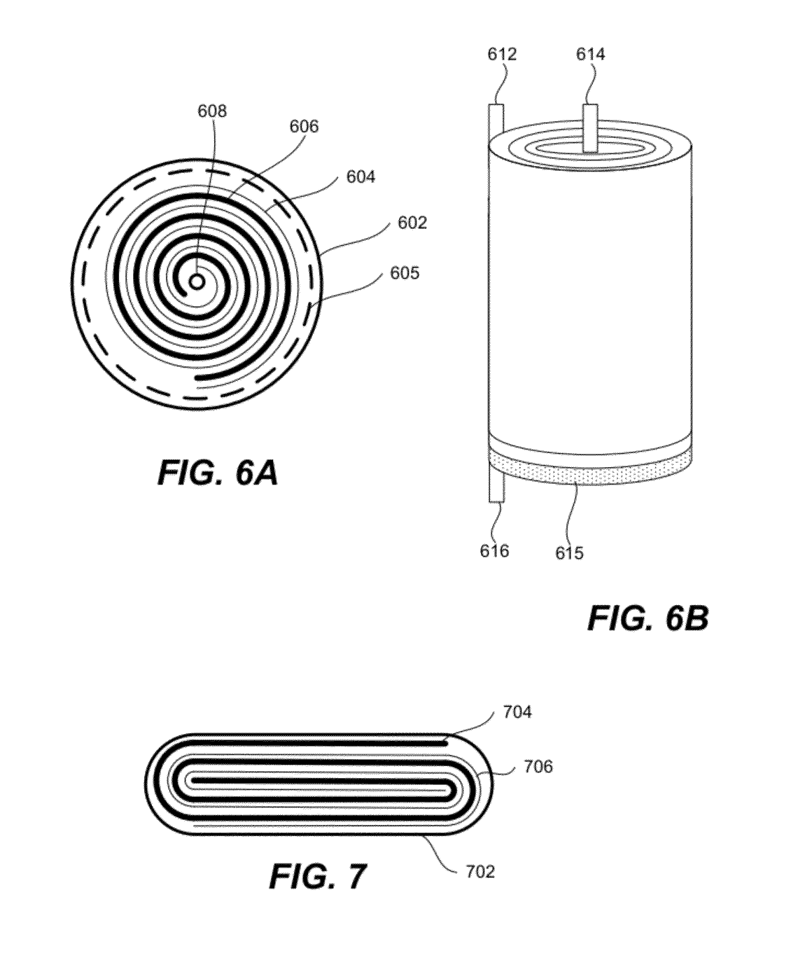

FIG. 7 illustrates a top view of a wound prismatic jellyroll. The jelly roll comprises a positive electrode 704 and a negative electrode 706. The white space between the electrodes is representative of the separator sheets. The jelly roll is inserted into a rectangular prismatic case. Unlike cylindrical jellyrolls shown in FIGS. 6A and 6B, the winding of the prismatic jellyroll starts with a flat extended section in the middle of the jelly roll. In one embodiment, the jelly roll may include a mandrel (not shown) in the middle of the jellyroll onto which the electrodes and separator are wound. Auxiliary electrodes in cells having prismatic jellyroll may be positioned in a manner similar to cells with round jellyrolls as described above.

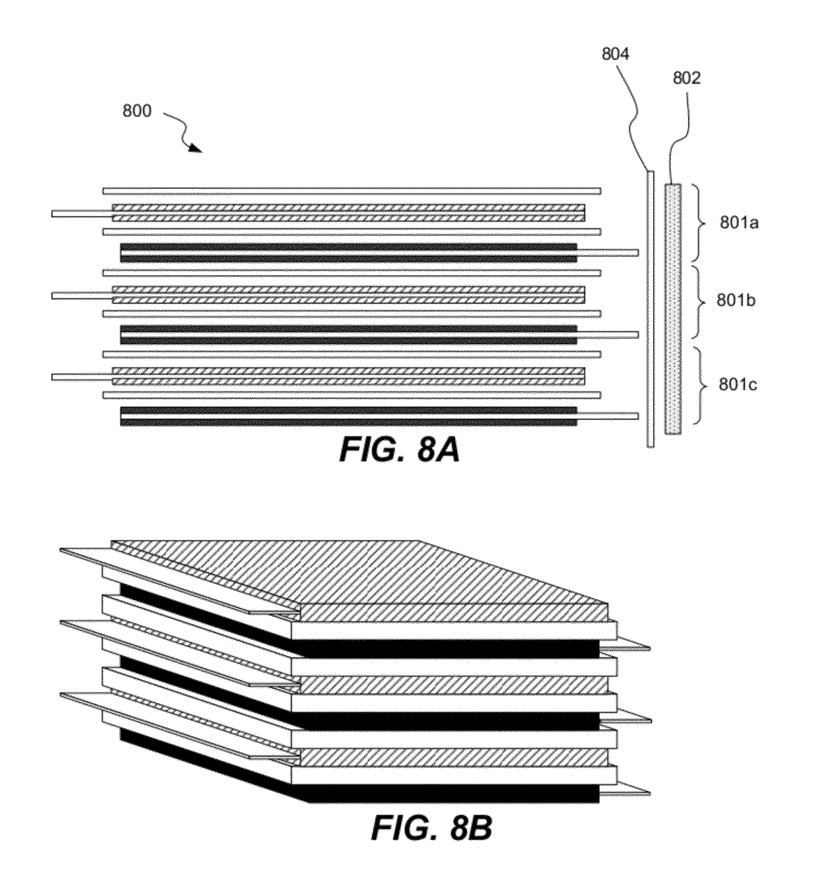

FIGS. 8A-8B illustrates side and perspective schematic view of a stacked cell assembly 800 including a plurality of sets (801a, 801b, and 801c) of alternating positive and negative electrodes and a separator in between the electrodes. One advantage of a stacked cell is that its stack can be made to almost any shape, and is particularly suitable for prismatic cells. However, such cell typically requires multiple sets of positive and negative electrodes and a more complicated alignment of the electrodes. The current collector tabs typically extend from each electrode and connected to an overall current collector leading to the cell terminal. Auxiliary electrode 802 may be positioned at along one edge of this stack as shown in FIG. 8A. A separator 804 may be provided between auxiliary electrode 802 and the stack to prevent any shorten of auxiliary electrode 802 and electrodes of the stack.

Once the electrodes are arranged as described above, the cell is filled with electrolyte. The electrolyte in lithium ions cells may be liquid, solid, or gel. The lithium ion cells with the solid electrolyte also referred to as a lithium polymer cells.

A typical liquid electrolyte comprises one or more solvents and one or more salts, at least one of which includes lithium. During the first charge cycle (sometimes referred to as a formation cycle), the organic solvent in the electrolyte can partially decompose on the negative electrode surface to form a solid electrolyte interphase layer (SEI layer). The interphase is generally electrically insulating but ionically conductive, allowing lithium ions to pass through. The interphase also prevents decomposition of the electrolyte in the later charging sub-cycles.

Some examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitrites (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), and organic compounds containing an S═O group (e.g., dimethyl sulfone and divinyl sulfone), and combinations thereof

Non-aqueous liquid solvents can be employed in combination. Examples of the combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester. Moreover, a cyclic carbonate may be combined with a lactone and a linear ester. In a specific embodiment, the ratio of a cyclic carbonate to a linear ester is between about 1:9 to 10:0, preferably 2:8 to 7:3, by volume.

A salt for liquid electrolytes may include one or more of the following: LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), and combination of thereof. Common combinations include LiPF₆ and LiBF₄, LiPF₆ and LiN(CF₃SO₂)₂, LiBF₄ and LiN(CF₃SO₂)₂.

In one embodiment the total concentration of salt in a liquid non-aqueous solvent (or combination of solvents) is at least about 0.3 M; in a more specific embodiment, the salt concentration is at least about 0.7M. The upper concentration limit may be driven by a solubility limit or may be no greater than about 2.5 M; in a more specific embodiment, no more than about 1.5 M.

A solid electrolyte is typically used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as Polyvinylidene fluoride (PVDF) or chloride or copolymer of their derivatives, Poly(chlorotrifluoroethylene), poly(ethylene-chlorotrifluoro-ethylene), or poly(fluorinated ethylene-propylene), Polyethylene oxide (PEO) and oxymethylene linked PEO, PEO-PPO-PEO crosslinked with trifunctional urethane, Poly(bis(methoxy-ethoxy-ethoxide))-phosphazene (MEEP), Triol-type PEO crosslinked with difunctional urethane, Poly((oligo)oxyethylene)methacrylate-co-alkali metal methacrylate, Polyacrylonitrile (PAN), Polymethylmethacrylate (PNMA), Polymethylacrylonitrile (PMAN), Polysiloxanes and their copolymers and derivatives, Acrylate-based polymer, other similar solvent-free polymers, combinations of the foregoing polymers either condensed or cross-linked to form a different polymer, and physical mixtures of any of the foregoing polymers. Other less conductive polymers may be used in combination with the above polymers to improve strength of thin laminates include: polyester (PET), polypropylene (PP), polyethylene napthalate (PEN), polyvinylidene fluoride (PVDF), polycarbonate (PC), polyphenylene sulfide (PPS), and polytetrafluoroethylene (PTFE).

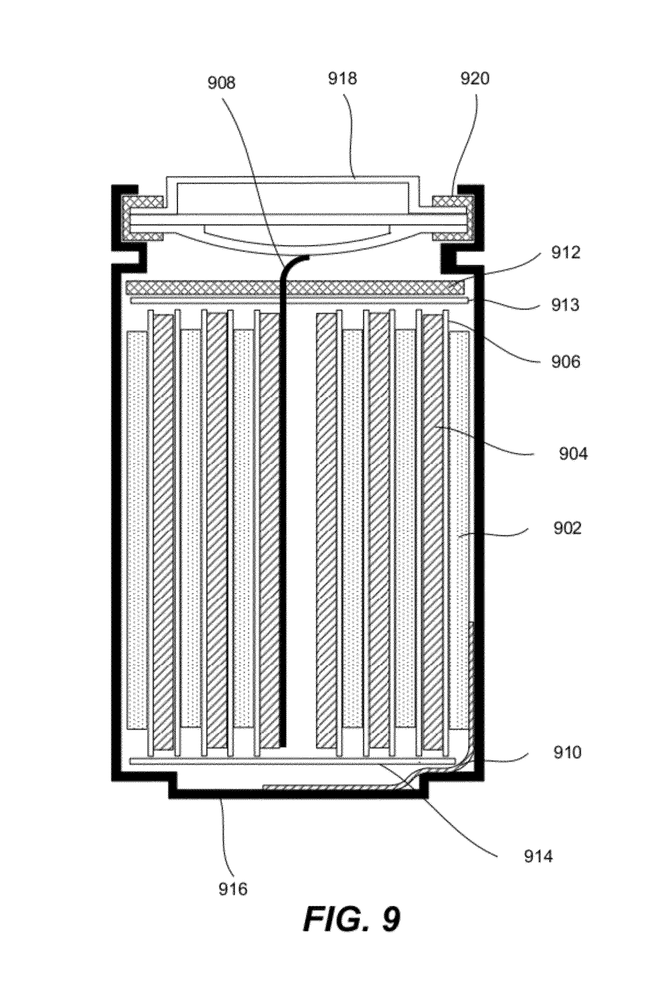

FIG. 9 illustrates a cross-section view of the wound cylindrical cell in accordance with one embodiment. A jelly roll comprises a spirally wound positive electrode 902, a negative electrode 904, and two sheets of the separator 906. The jelly roll is inserted into a cell case 916, and a cap 918 and gasket 920 are used to seal the cell. In some cases, cap 918 or case 916 includes a safety device. For example, a safety vent or burst valve may be employed to break open if excessive pressure builds up in the battery. Also, a positive thermal coefficient (PTC) device may be incorporated into the conductive pathway of cap 918 to reduce the damage that might result if the cell suffered a short circuit. The external surface of the cap 918 may used as the positive terminal, while the external surface of the cell case 916 may serve as the negative terminal. In an alternative embodiment, the polarity of the battery is reversed and the external surface of the cap 918 is used as the negative terminal, while the external surface of the cell case 916 serves as the positive terminal. Tabs 908 and 910 may be used to establish a connection between the positive and negative electrodes and the corresponding terminals. Appropriate insulating gasket 914 may be inserted to prevent the possibility of internal shorting. For example, a Kapton™ film may used for internal insulation. During fabrication, the cap 918 may be crimped to the case 916 in order to seal the cell. However prior to this operation, electrolyte (not shown) is added to fill the porous spaces of the jelly roll.

An auxiliary electrode 912 may be positioned on one side of the jelly roll, for example, under the cap 918. Auxiliary electrode 912 may be insulated from positive electrode 902 and negative electrode 904 by another separator piece 913. If auxiliary electrode 912 is positioned only temporarily in the assembly, then cap 918 may be removed in order to remove auxiliary electrode 912 from the assembly. Alternatively, cap 918 may be positioned only after auxiliary electrode 912 is removed.

A rigid case is typically required for lithium ion cells, while lithium polymer cells may be packed into a flexible, foil-type (polymer laminate) case. A variety of materials can be chosen for the case. For lithium-ion batteries, Ti-6-4, other Ti alloys, Al, Al alloys, and 300 series stainless steels may be suitable for the positive conductive case portions and end caps, and commercially pure Ti, Ti alloys, Cu, Al, Al alloys, Ni, Pb, and stainless steels may be suitable for the negative conductive case portions and end caps.

A lithium ion battery, which may form or be part of a cell pack or a battery pack, includes one or more lithium ion electrochemical cells of this invention, each containing electrochemically active materials. In addition to the cells, a lithium ion battery may also include a power management circuit to control balance power among multiple cells, control charge and discharge parameters, ensure safety (thermal and electrical runaways), and other purposes. Individual cells may be connected in series and/or in parallel with each other to form a battery with appropriate voltage, power, and other characteristics.

### Conclusion

Although the foregoing invention has been described in some detail for purposes of clarity of understanding, it will be apparent that certain changes and modifications may be practiced within the scope of the appended claims. It should be noted that there are many alternative ways of implementing the processes, systems and apparatus of the present invention. Accordingly, the present embodiments are to be considered as illustrative and not restrictive, and the invention is not to be limited to the details given herein.

What is claimed is:

1. A rechargeable electrochemical cell comprising:
a positive electrode having a positive electrode lithiation capacity; and
a negative electrode containing a high capacity active material and having a negative electrode lithiation capacity greater than the positive electrode lithiation capacity,
wherein a total amount of lithium in the rechargeable electrochemical cell contained in the positive electrode and the negative electrode exceeds the positive electrode lithiation capacity.

2. The rechargeable electrochemical cell of claim 1, wherein the high capacity active material is selected from the group consisting of silicon, tin, and germanium.

3. The rechargeable electrochemical cell of claim 1, wherein the negative electrode retains a predetermined minimal amount of lithium at any point during cycling of the rechargeable electrochemical cell.

4. The rechargeable electrochemical cell of claim 3, wherein the predetermined minimal amount of lithium corresponds to at least about 500 mAh/g based on the mass of the high capacity active material.

5. The rechargeable electrochemical cell of claim 3, wherein the predetermined minimal amount of lithium corresponds to a voltage of the negative electrode versus lithium of less than about 200 mV.

6. A rechargeable electrochemical cell comprising:
a positive electrode having a positive electrode lithiation capacity;
a negative electrode containing a high capacity active material and having a negative electrode lithiation capacity greater than the positive electrode lithiation capacity; and
an auxiliary electrode in ionic communication with the positive electrode and the negative electrode, the auxiliary electrode comprising lithium.

7. The rechargeable electrochemical cell of claim 6, wherein the high capacity active material is selected from the group consisting of silicon, tin, and germanium.

8. The rechargeable electrochemical cell of claim 6, further comprising a cell management circuit in electrical communication with the positive electrode, the negative electrode, and the auxiliary electrode, the cell management circuit configured to independently measure and maintain voltages at predetermined levels between the negative electrode and the auxiliary electrode and between the positive electrode and the auxiliary electrode.

9. The rechargeable electrochemical cell of claim 6, wherein the negative electrode is maintained such that the voltage between the negative electrode and the auxiliary electrode at a level is less than about 200 mV.

10. The rechargeable electrochemical cell of claim 6, further comprising a second auxiliary electrode, wherein the auxiliary electrode and the second auxiliary electrode are positioned adjacent to two opposite edges of the negative electrode.

11. The rechargeable electrochemical cell of claim 6, wherein the positive and negative electrodes are arranged into a jelly roll, the auxiliary electrode is positioned adjacent to one end of the jelly roll.

12. The rechargeable electrochemical cell of claim 6, wherein the positive and negative electrodes are arranged into a stack, the auxiliary electrode is positioned along one edge of the stack.

13. The rechargeable electrochemical cell of claim 6, wherein the auxiliary electrode comprises lithium foil.

14. The rechargeable electrochemical cell of claim 6, wherein a total amount of lithium in the rechargeable electrochemical cell contained in the positive electrode, the negative electrode, and the auxiliary electrode exceeds the positive electrode lithiation capacity.

15. A method of fabricating a rechargeable electrochemical cell comprising:
providing a cell assembly comprising:
a positive electrode;
a negative electrode containing a high capacity active material;
an auxiliary electrode comprising lithium; and
an electrolyte providing ionic communication among the positive electrode, the negative electrode, and the auxiliary electrode; and
causing an electrical current to flow between the negative electrode and the auxiliary electrode to transfer at least a portion of the lithium from the auxiliary electrode to the negative electrode.

16. The method of claim 15, wherein lithium is transferred from the auxiliary electrode to the negative the electrical until a voltage between the negative electrode and the auxiliary electrode is less than about 200 mV.

17. The method of claim 15, wherein the electrical current has a rate of less than about C/10.

18. The method of claim 15, wherein lithium is transferred from the auxiliary electrode to the negative the electrical while the cell assembly is heated to at least about 30° C.

19. The method of claim 15, wherein lithium is transferred from the auxiliary electrode to the negative the electrical until at least about 75% of lithium initially present on the auxiliary electrode is transferred to the negative electrode.

20. The method of claim 15, wherein lithium is transferred from the auxiliary electrode to the negative the electrical until at least about 500 mAh/g of lithium, based on the mass of the high capacity active material, is transferred from the auxiliary electrode to the negative electrode.

21. The method of claim 15, wherein lithium is transferred from the auxiliary electrode to the negative the electrical until substantially no lithium remains on the auxiliary electrode.

22. The method of claim 15, further comprising, after transferring the portion of the lithium from the auxiliary electrode to the negative electrode, conducting one or more formation cycles such that the negative electrode continues to retain the portion of the lithium transferred from the auxiliary electrode during the one or more formation cycles.

23. The method of claim 22, wherein conducting the one or more formation cycles comprises monitoring (i) a positive electrode voltage between the positive electrode and the auxiliary electrode and/or (ii) a negative electrode voltage between the negative electrode and the auxiliary electrode.

24. The method of claim 22, further comprising:
removing the auxiliary electrode from the cell assembly; and
sealing the positive electrode and the negative electrode inside a cell case.

25. The method of claim 24, wherein the auxiliary electrode is provided on a temporary structure used for containment of the electrolyte in the cell assembly while transferring lithium from the auxiliary electrode to the negative.

26. The method of claim 24, further comprising outgassing the cell assembly prior to sealing the positive electrode and the negative electrode inside the cell case.

27. The method of claim 24, further comprising removing a portion of the electrolyte from the cell assembly prior to sealing the positive electrode and the negative electrode inside the cell case.

28. The method of claim 24, further comprising replacing at least a portion of the electrolyte from the cell assembly prior to sealing the positive electrode and the negative electrode inside the cell case with a new electrolyte, wherein the new electrolyte has a higher conductivity than the portion of the electrolyte removed from the cell.

29. The method of claim 28, wherein the portion of the electrolyte is replaced after transferring the portion of the lithium from the auxiliary electrode to the negative electrode but prior to conducting the one or more formation cycles.

30. The method of claim 28, wherein the portion of the electrolyte is replaced after conducting the one or more formation cycles.

31. The method of claim 28, wherein the new electrolyte comprises at least about 0.5M of a lithium containing salt and wherein the portion of the electrolyte removed from the cell comprises less than about 0.1M of the lithium containing salt.

32. The method of claim 15, further comprising:
replacing the auxiliary electrode with a replacement auxiliary electrode; and
sealing the positive electrode, the negative electrode, and the replacement auxiliary electrode inside a cell case.

33. The method of claim 32, wherein the replacement auxiliary electrode includes a greater amount of lithium than the auxiliary electrode at the time of replacement.

34. The method of claim 32, further comprising, after sealing the positive electrode, the negative electrode, and the replacement auxiliary electrode inside the cell case, transferring additional lithium from the replacement auxiliary electrode to the negative electrode.

35. A lithium ion battery apparatus comprising:
a cell including:
a negative electrode comprising a high-capacity active material,
a positive electrode, and
an auxiliary electrode in ionic communication with the negative electrode and the positive electrode; and
control logic configured to cut off discharge of the cell when the high-capacity active material in the negative electrode reaches a cut off lithiation level of about 500 mAh/g or greater.
